(19) United States
(12) Patent Application Publication
(10) Pub. No.: US 2026/0229938 A1
(43) Pub. Date: Aug. 6, 2026

(54) ROTOR ARRANGEMENT FOR A WHEEL HUB MOTOR

(71) Applicant: AUDI AG, Ingolstadt (DE)

(72) Inventor: Thomas KLINGER, Ingolstadt (DE)

(21) Appl. No.: 19/530,136

(22) Filed: Feb. 4, 2026

(30) Foreign Application Priority Data
Feb. 5, 2025 (DE) 102025104206.3

(51) Int. Cl. H02K 1/26; H02K 1/16; H02K 7/00

(52) U.S. Cl. CPC H02K 1/26; H02K 1/16; H02K 7/006

(57) ABSTRACT

A rotor arrangement is disclosed, and may include at least two rotor windings, at least two rotor cores, and a rim having an axis of rotation. The at least two rotor windings and the at least two rotor cores are configured to conduct a magnetic flux, and such that the magnetic flux can be induced into the at least two rotor cores by the at least two rotor windings. Each rotor core of the at least two rotor cores has a first end and a second end. The first ends of the at least two rotor cores and the rotor windings may be arranged in a region of the axis of rotation of the rim. Each rotor core of the at least two rotor cores may extend radially and/or axially from the respective first end along a contour of the rim. Further disclosed are a rim, a wheel hub motor and a vehicle having such a rotor arrangement.

### BACKGROUND

### Technical Field

The present disclosure relates to a rotor arrangement for a wheel hub motor, particularly a rotor arrangement integrated with a rim.

### Description of the Related Art

When designing wheel hub motors, the electric motor or electric machine is not usually integrated into the rim of the vehicle's wheels. The electric motor is connected to the rim on the inside or on a side of the rim facing the vehicle. Depending on the design, the rim may also be attached to the wheel hub motor using standard rim bolts.

Solutions are already known in which an external rotor or a rotor of the wheel hub motor is integrated into the rim or connected to the rim. However, such an integration of the wheel hub motor in an embodiment as a synchronous motor requires external rotors with permanent magnets, or a short-circuit cage in an embodiment as an asynchronous motor. WO2010/03538A1, for example, discloses such a vehicle wheel with an external rotor of an asynchronous motor. The windings on the wheel side of the external rotor must be connected to the power electronics via a plurality of sliding contacts.

EP3468003A1, for example, describes a rim for a vehicle in which permanent magnets of an external rotor are installed. DE102021127658A1 also describes a synchronous motor of this type, in which a rotor ring with permanent magnets is attached to the inside of a rim.

### BRIEF SUMMARY

The present disclosure provides a technically simple wheel hub motor in the form of an asynchronous motor without the need for permanent magnets.

According to an aspect of the present disclosure, a rotor arrangement for a rim is provided. The rotor arrangement may have at least two rotor windings and at least two rotor cores for conducting a magnetic flux which may be induced into the rotor cores by the at least two rotor windings. For this purpose, each rotor core has a first end and a second end. The magnetic flux may be bundled and directed from the first end to the second end of the respective rotor core. The second end of the rotor cores may be configured in such a way that interaction with a stator is possible. For this purpose, the second ends of the rotor cores may face corresponding stator windings and/or stator cores.

The rotor arrangement also has a rim. According to the present disclosure, the first ends of the rotor cores and the rotor windings may be arranged in the region of an axis of rotation of the rim. Starting from the first ends, the rotor cores may extend radially and/or axially along a contour of the rim. By arranging the rotor windings in the region of the axis of rotation of the rim, the rotor windings may be configured to be static or rotationally fixed in relation to the rim and the rotor cores, which may eliminate the need for sliding contacts.

The region of the axis of rotation may be defined as a space which is formed in the axial direction between the rim and a wheel hub supporting the rim. The rim may limit this region of the axis of rotation circumferentially or radially.

Alternatively, the rotor windings may be configured to rotate with the rim, wherein the proximity to the axis of rotation may minimize the wear of sliding contacts.

The rotor cores may also follow a contour of the rim and thus, may have an increased radius, whereby the rotor arrangement may contribute to an increase in the possible torque in a wheel hub motor with such a rotor arrangement. Advantageously, the second ends of the rotor cores may be arranged in the region of a rim flange, a rim bed and/or in the region of spokes of the rim. The second ends may be arranged alternately offset in position to each other, for example, to form a claw pole arrangement.

According to a further aspect of the present disclosure, a rim with a rotor arrangement according to the present disclosure is provided. In addition to the many possibilities for increasing the performance of the wheel hub motor, the rotor arrangement may also contribute to increasing the mechanical strength of the rim.

According to a further aspect of the present disclosure, a wheel hub motor with a rotor arrangement according to the present disclosure is provided. The wheel hub motor may have a stator with at least two stator windings. Depending on the configuration, stator cores may also be provided to concentrate and direct the magnetic flux generated by the stator windings. The at least two stator windings may be configured to interact electromagnetically with the second ends of the at least two rotor cores of the rotor arrangement.

The wheel hub motor may be configured as a permanently excited synchronous motor with the rim as an external rotor in a claw pole arrangement, wherein the rotor windings may be configured to be stationary or non-rotating, depending on the design.

According to a further aspect of the disclosure, a vehicle is provided which has at least one wheel hub motor according to the disclosure. In analogy to the rotor windings, the stator windings can be positioned statically or in a rotationally fixed manner in relation to the rim. The stator windings and the rotor windings can be attached to the vehicle, for example, to a wheel bearing mount.

In some embodiments, at least one rotor core is configured as an iron yoke made of a solid material or as a lamination stack. Such a configuration may enable the rotor cores to be configured in a technically versatile way and adapted to different requirements.

According to some embodiments, the at least two rotor cores extend along the outside of the rim. This configuration may enable the rotor cores to be attached to the rim and follow the shape or contour of the rim, at least in certain regions. The rotor cores connected to the rim may therefore have a reinforcing effect on the rim.

According to some embodiments, the at least two rotor cores are formed as parts of a rim designed as a composite rim. This configuration may enable the rotor cores to be integrated into the rim and to shape the rim in certain regions. The integration of the rotor cores into the rim may increase the mechanical strength of the rim.

The first ends of the rotor cores may be arranged in the region of the axis of rotation and may rotate next to or within rotor windings. As the rotor cores extend further, the rotor cores may split into the respective rim spokes and lead into the second ends.

The rim may comprise cast aluminum, for example. The respective rotor cores, which may be formed from a solid material, may comprise iron or a ferromagnetic metal alloy and/or ferrite, for example. The rotor cores may comprise an identical material or different rotor cores may be made of different materials. Parts of the rotor cores and/or the first ends and/or the second ends may protrude from the rim at least in certain regions.

According to some embodiments, the at least two rotor windings are arranged in the region of the axis of rotation of the rim, wherein the at least two rotor windings are rotationally symmetrical with respect to the axis of rotation. This configuration may enable a compact design of the rotor arrangement. Stator cores and stator windings may be arranged radially next to the rotor windings, making particularly optimal use of the space within the rim.

According to some embodiments, the at least two rotor windings are arranged to be rotationally fixed relative to the first ends of the rotor cores. As a result, wear-prone sliding contacts can be eliminated and the rotor arrangement can be designed to be particularly durable and technically simple.

According to some embodiments, the first ends of the at least two rotor cores are arranged axially offset from one another along the axis of rotation of the rim, wherein the at least two rotor windings may be arranged around the first ends of the rotor cores in such a way that the first ends may be rotated along the rotor windings when the rim rotates about the axis of rotation. In this way, a wheel hub may serve as an extension for the rotor cores or allow the rotor cores to be extended so that the positioning of the rotor windings is particularly flexible. For example, a rotor core may protrude through the wheel hub and lead into the first end, creating more installation space for different rotor windings. In some embodiments, the distance between the rotor windings may be set smaller so that the rotor windings are arranged next to each other on one side of the wheel hub. The common side of the wheel hub may face towards the rim or wheel (outside) or face away from the rim or wheel (inside).

In some embodiments, protection against accidental contact with the rotor cores may be provided. For example, the rim may be closed with an electrically insulating hub cap. Alternatively or additionally, the rotor cores may be arranged in a form that is insulated with respect to the rim.

### BRIEF DESCRIPTION OF THE SEVERAL VIEWS OF THE DRAWINGS

FIG. 1 shows a schematic sectional view of a wheel hub motor with a rotor arrangement according to an exemplary embodiment of the present disclosure.

FIG. 2 shows a schematic sectional view of a wheel hub motor with a rotor arrangement according to a further exemplary embodiment according to the present disclosure.

FIG. 3 shows a perspective view of a rim of FIG. 1.

FIG. 4 shows a side view of a vehicle with a wheel hub motor according to an exemplary embodiment of the present disclosure.

### DETAILED DESCRIPTION

Elements and components with the same or similar design or functional features are given the same reference signs across all figures.

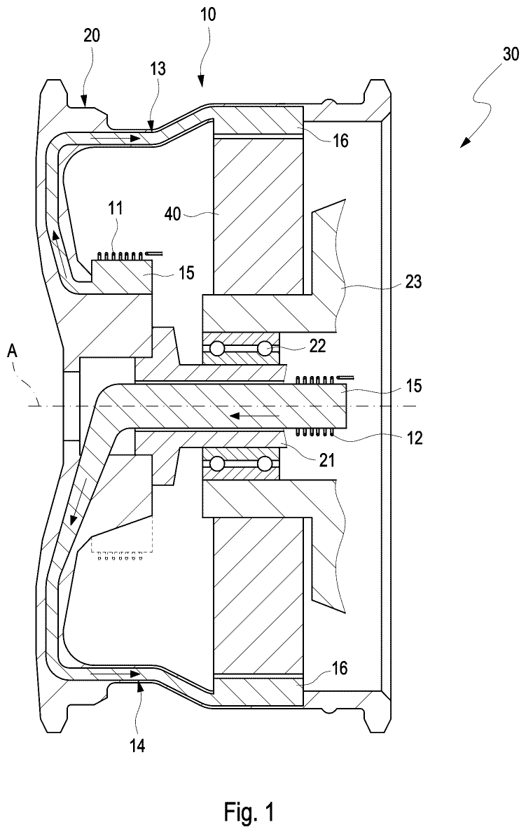

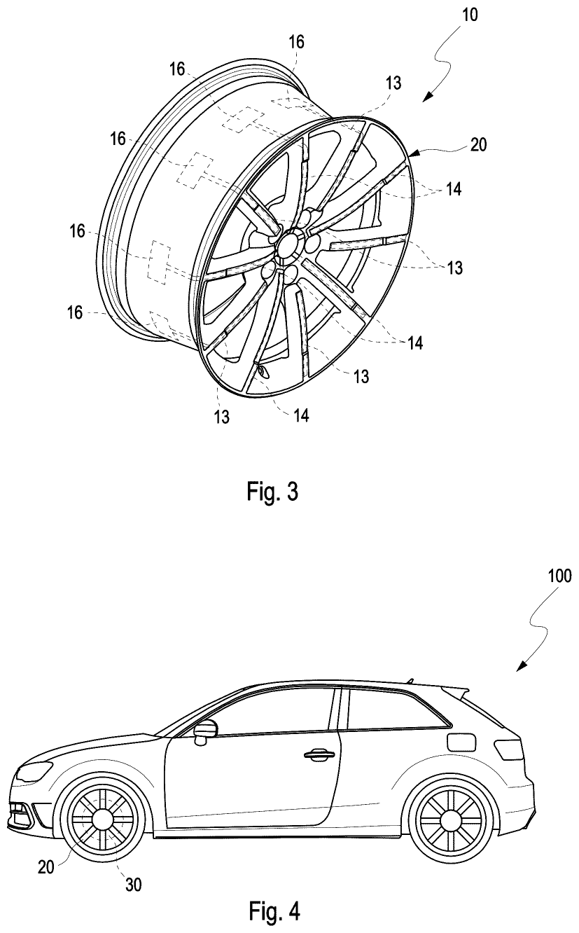

FIG. 1 shows a schematic sectional view of a wheel hub motor 30 with a rotor arrangement 10 according to an exemplary embodiment according to the present disclosure. In addition, FIG. 3 shows a perspective view of a rim 20 of the rotor arrangement 10 from FIG. 1. To illustrate the operating principle of the rotor arrangement 10, the rim 20 is shown without a tire and is configured to be installed in a vehicle 100, which is illustrated in FIG. 4 by way of example.

The rim 20 is configured as part of the rotor arrangement 10. Furthermore, the rotor arrangement may have a plurality of rotor windings 11, 12 and a plurality of rotor cores 13, 14 for conducting a magnetic flux which may be induced into the rotor cores 13, 14 by the rotor windings 11, 12. Two different types of rotor cores 13, 14 and rotor windings 11, 12 are shown by way of example.

Each rotor core 13, 14 has a first end 15 and a second end 16. The rotor windings 11, 12 may be configured to induce a magnetic flux via the first end 15. The induced magnetic flux may be conducted to the second ends 16 via the rotor cores 13, 14.

A first rotor winding 11 may be used to induce a magnetic flux in all first rotor cores 13. A second rotor winding 12 may be used to induce a magnetic flux in all second rotor cores 14. The arrows illustrate a possible magnetic flux through the rotor cores 13, 14.

The rotor cores 13, 14 may be integrated into the rim 20 and extend radially and axially from the first ends 15 along a contour of the rim 20.

The first ends 15 of the rotor cores 13, 14 and the rotor windings 11, 12 may be arranged in the region of an axis of rotation A of the rim 20. The rim 20 is attached, by way of example, to a wheel hub 21, which is supported by a wheel bearing 22.

The two rotor windings 11, 12 may be arranged on opposite sides of the wheel hub 21 and thus, may be axially spaced apart from each other in the direction of the axis of rotation A by the wheel hub 21 and the wheel bearing 22.

The first rotor cores 13 may be positioned exclusively on the rim 20, wherein the first ends 15 lead into the region of the axis of rotation A next to the wheel hub 21 and may be surrounded by a rotationally symmetrical rotor winding 11. In some embodiments, first ends 15 of the first rotor cores 13 may rotate freely within this first rotor winding 11. The first rotor winding 11 may be arranged in a rotationally fixed manner and may be attached to the vehicle or to the wheel carrier 23.

The second rotor cores 14 may protrude through the wheel hub 21 on the inside. The first ends 15 of the second rotor cores 14 may be arranged on a side of the wheel bearing 22 opposite the first ends 15 of the first rotor cores 13 and thus, offset in position.

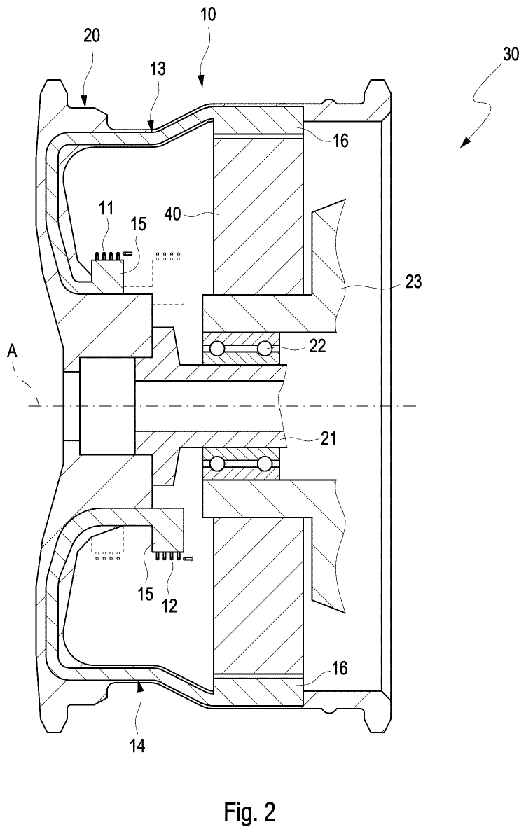

As an alternative to the embodiment shown in FIG. 1, FIG. 2 shows a schematic sectional view of a wheel hub motor 30 with a rotor arrangement 10 according to a further exemplary embodiment according to the present disclosure. The two rotor windings 11, 12 may be positioned next to each other on a common side of the wheel hub 21. FIG. 2 illustrates that the axial distance along the axis of rotation A between the rotor windings 11, 12 may be set smaller.

The second ends 16 of all rotor cores 13, 14 may lead into the radially outer region of the rim 20, and may all lie on a common axial plane, wherein the second ends 16 of the first rotor cores 13 and the second ends 16 of the second rotor cores 14 may alternate with one another and thus, form a claw-pole arrangement.

Furthermore, the wheel hub motor 30 may have a stator 40 with stator windings. The details of the stator 40, such as stator cores, stator windings and the like, are not depicted for the sake of clarity.

The second ends 16 of the rotor cores 13, 14 may be configured in such a way that interaction with the stator 40 is possible. For this purpose, the second ends 16 of the rotor cores 13, 14 may face corresponding stator windings and/or stator cores of the stator 40 in order to generate a torque.

FIG. 4 shows a side view of a vehicle 100 with a wheel hub motor 30 according to an exemplary embodiment according to the present disclosure. By way of example, the vehicle 100 may have a wheel hub motor 30 on each of its front wheels. Each wheel hub motor 30 may have a rotor arrangement 10 with the rim 20.

German patent application no. 102025104206.3, filed Feb. 5, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor arrangement comprising:
at least two rotor windings;
at least two rotor cores, each rotor core of the at least two rotor cores having a first end and a second end; and
a rim having an axis of rotation,
wherein the at least two rotor windings and the at least two rotor cores are configured to conduct a magnetic flux, and such that the magnetic flux can be induced into the at least two rotor cores by the at least two rotor windings,
wherein the first ends of the at least two rotor cores and the at least two rotor windings are arranged in a region of the axis of rotation of the rim, and
wherein each of the at least two rotor cores extend radially and/or axially from the respective first end along a contour of the rim.

2. The rotor arrangement according to claim 1, wherein at least one rotor core of the at least two rotor cores is configured as an iron yoke comprising a solid material or as a lamination stack.

3. The rotor arrangement according to claim 1, wherein the at least two rotor cores extend along the rim on exterior of the rim.

4. The rotor arrangement according to claim 1, wherein the at least two rotor cores are configured as portions of the rim, such that the rim is a composite rim.

5. The rotor arrangement according to claim 1, wherein the at least two rotor windings are arranged in the region of the axis of rotation of the rim, and
wherein the at least two rotor windings are shaped rotationally symmetrically with respect to the axis of rotation.

6. The rotor arrangement according to claim 1, wherein the at least two rotor windings are configured to be rotationally fixed relative to the first ends of the rotor cores.

7. The rotor arrangement according to claim 6, wherein the at least two rotor windings are arranged on a wheel carrier.

8. The rotor arrangement according to claim 1, wherein the first ends of the at least two rotor cores are arranged axially offset from one another along the axis of rotation of the rim, and
wherein the at least two rotor windings are arranged around the first ends of the at least two rotor cores such that the first ends are configured to rotate along the rotor windings when the rim is rotated about the axis of rotation.

9. A rim comprising:
a rotor arrangement including:
at least two rotor windings;
at least two rotor cores, each rotor core of the at least two rotor cores having a first end and a second end; and
wherein the at least two rotor windings and the at least two rotor cores are configured to conduct a magnetic flux, and such that the magnetic flux can be induced into the at least two rotor cores by the at least two rotor windings,
wherein the first ends of the at least two rotor cores and the at least two rotor windings are arranged in a region of an axis of rotation of the rim, and
wherein each of the at least two rotor cores extend radially and/or axially from the respective first end along a contour of the rim.

10. A wheel hub motor comprising:
a rotor arrangement including:
a stator including at least two stator windings;
at least two rotor windings;
at least two rotor cores, each rotor core of the at least two rotor cores having a first end and a second end; and
a rim having an axis of rotation,
wherein the at least two rotor windings and the at least two rotor cores are configured to conduct a magnetic flux, and such that the magnetic flux can be induced into the at least two rotor cores by the at least two rotor windings,
wherein the first ends of the at least two rotor cores and the at least two rotor windings are arranged in a region of the axis of rotation of the rim,
wherein each of the at least two rotor cores extend radially and/or axially from the respective first end along a contour of the rim, and
wherein the at least two stator windings are configured to interact electromagnetically with the second ends of at least two rotor cores of the rotor arrangement.

11. A vehicle comprising at least one wheel hub motor according to claim 10.
